(19) United States
(12) Patent Application Publication
(10) Pub. No.: US 2009/0189880 A1
(43) Pub. Date: Jul. 30, 2009

(54) SOURCE DRIVING CIRCUIT

(75) Inventors: Hung-Chun Li, Taoyuan County (TW); Mu-Shan Liao, Taoyuan County (TW); Tung-Hsin Lan, Taipei City (TW); Yuan-Jing Chang, Kaohsiung City (TW); Ming-Chang Lin, Tainan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taipei (TW)

(21) Appl. No.: 12/177,164

(22) Filed: Jul. 22, 2008

(30) Foreign Application Priority Data
Jan. 30, 2008 (TW) 97103476

(51) Int. Cl. G06F 3/038

(52) U.S. Cl. 345/205

(57) ABSTRACT

A source driving circuit is provided. The source driving circuit includes a plurality of source drivers, first switches, and second switches. Each transmission line of each source driver is coupled to the first switch and the second switch. In a first period, the first switches are turned on, and the source drivers generate a first driving signal to drive pixels in odd columns of a display panel through the transmission lines and the first switches. In a second period, the second switches are turned on, and the source drivers generate a second driving signal to drive pixels in even columns of the display panel through the transmission lines and the second switches. Therefore, the problem of the prior art that each transmission line of the source driver drives pixels in only one column of the display panel is improved and the hardware cost is greatly decreased.

### CROSS-REFERENCE TO RELATED APPLICATION

This application claims the priority benefit of Taiwan application serial no. 97103476, filed on Jan. 30, 2008. The entirety of the above-mentioned patent application is hereby incorporated by reference herein and made a part of specification.

### BACKGROUND OF THE INVENTION

1. Field of the Invention

The present invention relates to a liquid crystal display (LCD), in particular, to a source driving circuit of an LCD.

2. Description of Related Art

FIG. 1 is a circuit diagram of a source driver in the prior art. Referring to FIG. 1, the source driver 100 converts a digital video data into an analog driving signal through a digital-analog converter 110, and transmits the analog driving signal to an output buffer 130 through transmission lines 120. Then, the analog driving signal drives every pixel P₁₀ through data lines 140. It should be noted that in the conventional source driver 100, each transmission line 120 is corresponding to one data line 140. That is to say, each transmission line 120 is merely corresponding to pixels in only one column. Therefore, the source driving circuit in the prior art requires for a large number of transmission lines and source drivers.

In view of the above, in the prior art, two thin film transistors (TFTs) are used to realize the pixels, so as to reduce the number of the source drivers. FIG. 2 is a circuit diagram of a display panel in the prior art. Referring to FIG. 2, the source driver 101 has a pin (output end) electrically connected to two data lines (141 and 142), and each data line is corresponding to pixels in two columns, such that the number of the source drivers 101 is reduced. However, each pixel of the display panel 150 must be implemented by two TFTs (T₁ and T₂), and controlled by two scan lines.

Moreover, provided that the TFTs T₁ and T₂ are N-channel transistors, when voltages of scan lines 152 and 154 are at a high potential, the data line 141 may charge the pixel P₁₁. When voltages of scan lines 151 and 152 are at a high potential, the data line 141 may charge the pixel P₁₂. When the voltages of the scan lines 153 and 154 are at a high potential, the data line 142 may charge the pixel P₁₃. When the voltages of the scan lines 151 and 153 are at a high potential, the data line 142 may charge the pixel P₁₄. Although the number of the source drivers 101 may be reduced in the above manner, each pixel requires for two TFTs, and thus the aperture ratio may be reduced.

FIG. 3 is a circuit diagram of another display panel in the prior art. Referring to FIG. 3, the source driver 102 has a pin (output end) electrically connected to one data line (143), and each data line is corresponding to pixels in two columns, so as to reduce the number of the source drivers 102. Provided that the TFTs T₃ and T₄ are N-channel transistors, when voltages of a scan line 155 and an enable line 161 are at a high potential, the data line 143 may charge the pixel P₂₁. When voltages of a scan line 156 and the enable line 161 are at a high potential, the data line 143 may charge the pixel P₂₂. When voltages of the scan line 156 and the enable line 162 are at a high potential, the data line 143 may charge the pixel P₂₃. When voltages of the scan line 157 and the enable line 162 are at a high potential, the data line 143 may charge the pixel P₂₄.

Although the number of the source drivers 101 may be reduced in the above manner, each pixel of a display panel 170 must be implemented by two TFTs (T₃ and T₄) and controlled by one scan line and one enable line. Therefore, the aperture ratio is reduced, and the hardware cost is increased.

### SUMMARY OF THE INVENTION

Accordingly, the present invention is directed to a source driving circuit. Each transmission line of each source driver is provided with first switches and second switches. Each transmission line is corresponding to pixels in at least two columns through the first switches and the second switches. Therefore, the number of the transmission lines in the source driver is reduced, and the hardware cost is decreased.

The present invention provides a source driving circuit adapted to a display panel. The source driving circuit includes a plurality of source drivers and a plurality of control circuits. Each control circuit is coupled to each source driver, and includes a plurality of first switches and second switches. In a first period, the source drivers output a first driving signal through a plurality of transmission lines. In a second period, the source drivers output a second driving signal through the above transmission lines. The first switches are respectively coupled to one of the transmission lines. In the first period, the first switches are turned on, such that the first driving signal is transmitted to pixels in odd columns of the display panel. The second switches are respectively coupled to one of the transmission lines. In the second period, the second switches are turned on, such that the second driving signal is transmitted to pixels in even columns of the display panel.

In an embodiment of the present invention, gate ends of the first switches are coupled to a timing controller, so as to receive a first control signal provided by the timing controller. Gate ends of the second switches are coupled to a timing controller, so as to receive a second control signal provided by the timing controller. A voltage level of the first control signal is opposite to that of the second control signal.

In an embodiment of the present invention, the timing controller includes a control signal generator, and the control signal generator includes an inverter and a level shifter. The inverter receives a first level signal, and generates a second level signal. The level shifter has a first input end, a second input end, a first output end, and a second output end respectively coupled to an input end of the inverter, an output end of the inverter, the gate ends of the first switches, and the gate ends of the second switches, so as to adjust the voltage level of the first level signal and the voltage level of the second level signal, thereby generating the first control signal and the second control signal.

In an embodiment of the present invention, the first switches and the second switches are N-channel transistors. In another embodiment, in the first period, the second switches stay in a turn-off state, and in the second period, the first switches stay in a turn-off state.

From another point of view, the present invention provides a source driving circuit adapted to a display panel. The source driving circuit includes a plurality of source drivers. Each source driver has a plurality of transmission lines and a plurality of first switches and second switches. The first switches are respectively coupled to one of the transmission lines. The second switches are respectively coupled to one of the transmission lines. In a first period, the first switches are turned on, and the source drivers provide a first driving signal to drive pixels in odd columns of the display panel through the transmission lines and the first switches. In a second period, the second switches are turned on, and the source drivers provide a second driving signal to drive pixels in even columns of the display panel through the transmission lines and the second switches.

In the present invention, each transmission line of each source driver is provided with the first switches and the second switches. In the first period, the first switches are turned on, and the source drivers generate a first driving signal to drive pixels in odd columns of the display panel through the transmission lines and the first switches. In the second period, the second switches are turned on, and the source drivers generate a second driving signal to drive pixels in even columns of the display panel through the transmission lines and the second switches. Therefore, the problem in the prior art that one transmission line is adopted to transmit a driving signal to pixels in only one column is improved and the hardware cost is greatly decreased.

In order to make the aforementioned and other objectives, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a source driver in the prior art.

FIG. 2 is a circuit diagram of a display panel in the prior art.

FIG. 3 is a circuit diagram of another display panel in the prior art.

FIG. 4A is an architectural view of an LCD according to a first embodiment of the present invention.

FIG. 4B is a circuit diagram of a control circuit according to the first embodiment of the present invention.

FIG. 4C is a circuit diagram of a display panel according to the first embodiment of the present invention.

FIG. 4D is a partial circuit diagram of a timing controller according to the first embodiment of the present invention.

FIG. 4E is a schematic view showing signal waveforms of each data line, each scan line, a control signal, and a clock signal according to the first embodiment of the present invention.

FIG. 5A is an architectural view of an LCD according to a second embodiment of the present invention.

FIG. 5B is an architectural view of a source driver according to the second embodiment of the present invention.

FIG. 5C is a circuit diagram of a control circuit according to the second embodiment of the present invention.

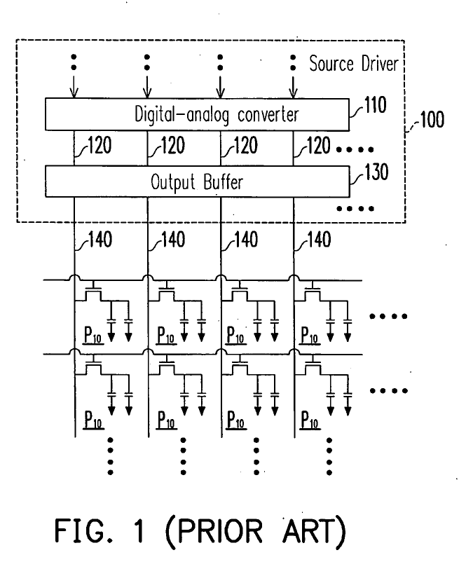

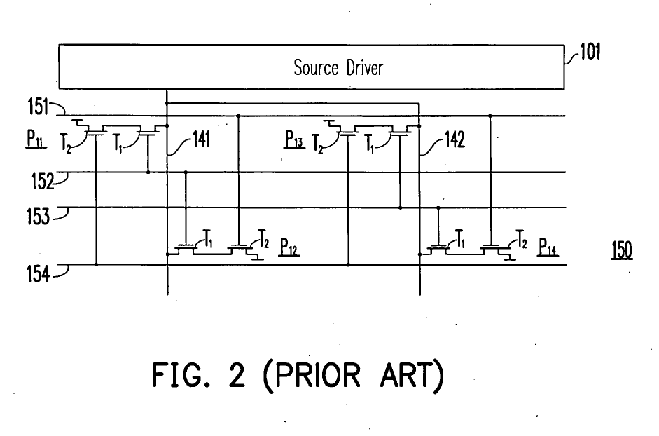

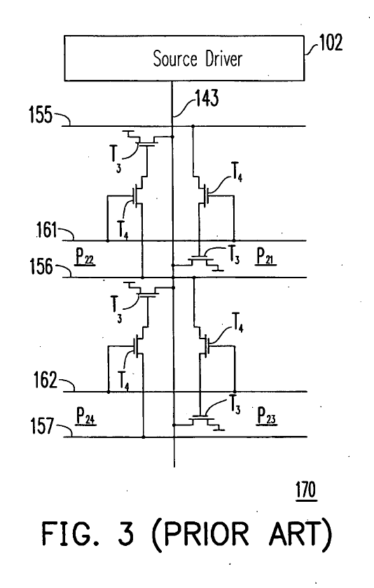

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

### The First Embodiment

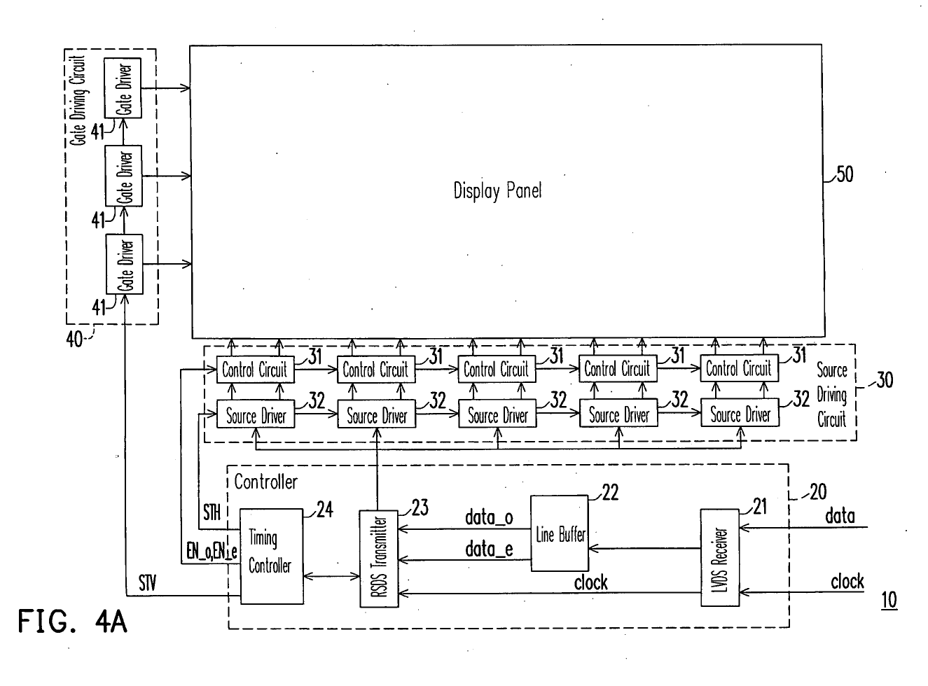

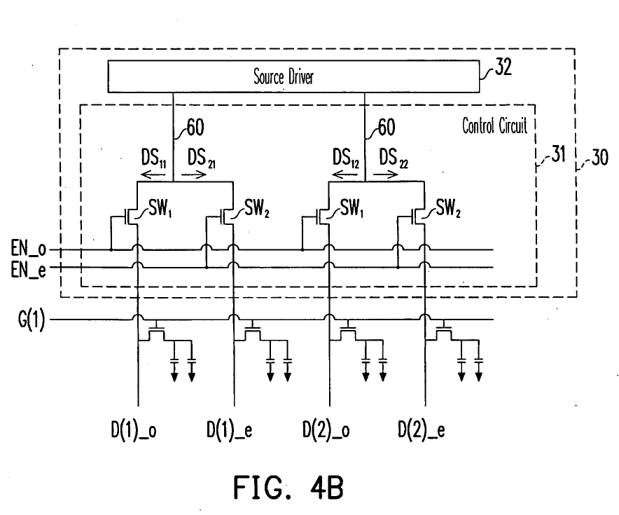

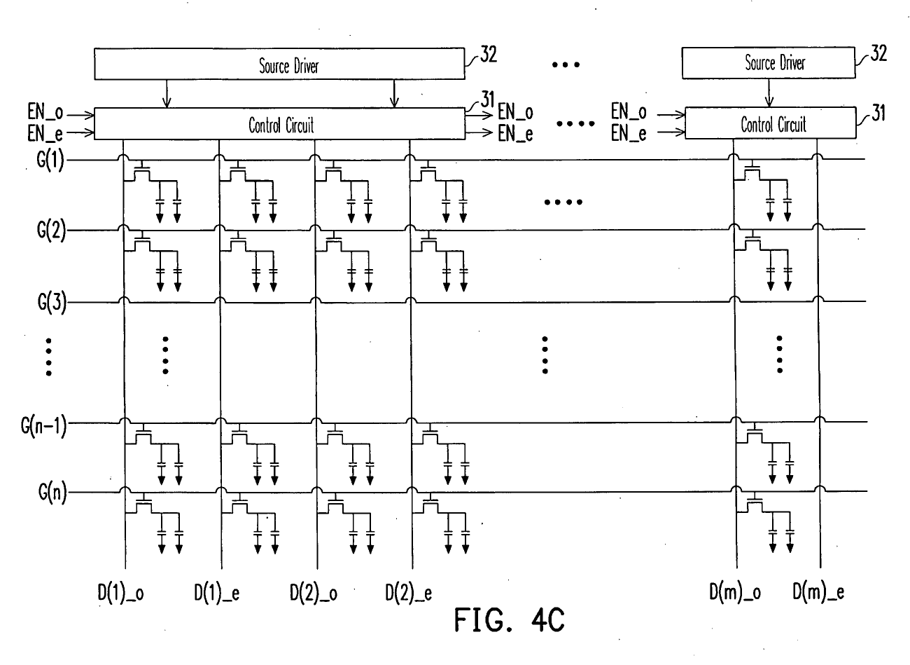

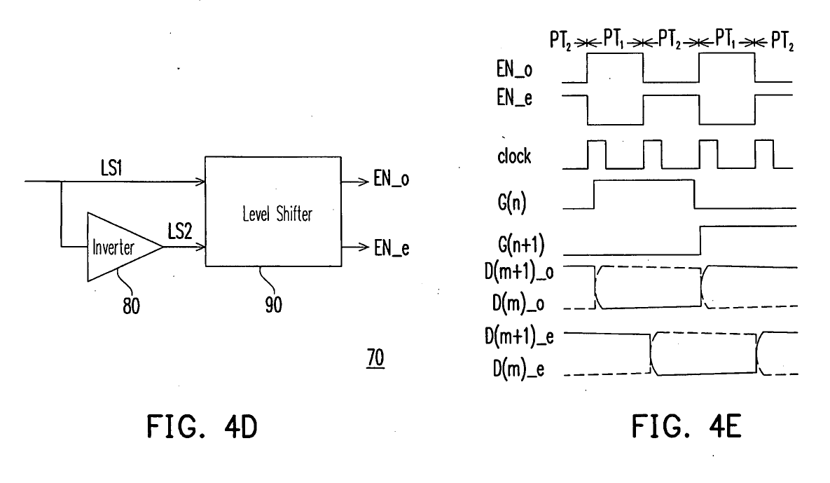

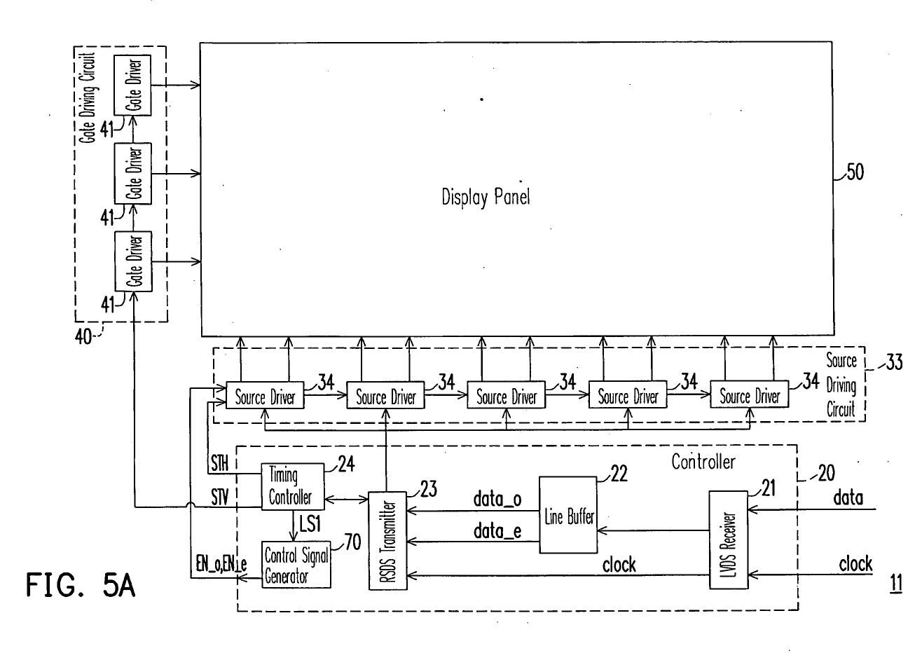

FIG. 4A is an architectural view of an LCD according to a first embodiment of the present invention. Referring to FIG. 4A, the LCD 10 includes a controller 20, a source driving circuit 30, a gate driving circuit 40, and a display panel 50. The controller 20 includes a low voltage differential signalling (LVDS) receiver 21, a line buffer 22, a reduced swing differential signaling (RSDS) transmitter 23, and a timing controller 24. The controller 20 receives a digital video data data and a clock signal clock, performs a data process on the digital video data data through the LVDS receiver 21. Then, the line buffer 22 divides the digital video data data into an odd line data data_o and an even line data data_e, and then performs a data process on the odd line data data_o and the even line data data_e and provides the data to the source driving circuit 30 through the RSDS transmitter 23.

Moreover, through the timing controller 24, the controller 20 further generates a vertical control signal STV to the gate driving circuit 40, and generates a horizontal control signal STH, a first control signal EN_o, and a second control signal EN_e to the source driving circuit 30. The gate driving circuit 40 includes a plurality of gate drivers 41. Persons skilled in the art would know the implementations of the gate driving circuit 40, and the details will not be described herein again. It should be noted that, the source driving circuit 30 of this embodiment includes a plurality of control circuits 31 and a plurality of source drivers 32. The source driving circuits 30 are, for example, disposed in a non-active region of the display panel 50.

FIG. 4B is a circuit diagram of a control circuit according to the first embodiment of the present invention. FIG. 4C is a circuit diagram of a display panel according to the first embodiment of the present invention. Referring to FIGS. 4A to 4C, each source driver 32 is coupled to a plurality of transmission lines 60. Each control circuit 31 is coupled to each source driver 32, and includes a plurality of first switches SW₁ and a plurality of second switches SW₂. In this embodiment, the first switches SW₁ and the second switches SW₂ are, for example, N-channel transistors. However, in other embodiments, the first switches SW₁ and the second switches SW₂ may also be implemented by other types of switches, such as P-channel transistors.

Moreover, each first switch SW₁ is coupled to one of the transmission lines 60. Each second switch SW₂ is coupled to one of the transmission lines 60. Furthermore, a gate end of each first switch SW₁ is coupled to the timing controller 24 of the controller 20, so as to receive the first control signal EN_o provided by the timing controller 24. A gate end of each second switch SW₂ is coupled to the timing controller 24, so as to receive the second control signal EN_e provided by the timing controller 24. In this embodiment, a voltage level of the first control signal EN_o is opposite to that of the second control signal EN_e. Hereinafter, the generation manner of the first control signal EN_o and the second control signal EN_e is illustrated in detail.

FIG. 4D is a partial circuit diagram of a timing controller according to the first embodiment of the present invention. Referring to FIGS. 4A and 4D, the timing controller 24 includes a control signal generator 70. The control signal generator 70 includes an inverter 80 and a level shifter 90. The inverter 80 may receive a first level signal LS1 generated within the timing controller 24, and transforms the voltage level of the first level signal LS1, thereby generating a second level signal LS2. The level shifter 90 adjusts the voltage level of the first level signal LS1 and the voltage level of the second level signal LS2. In this manner, the first control signal EN_o and the second control signal EN_e are generated. Hereinafter, the operating principle of the source driving circuit 30 is further illustrated.

FIG. 4E is a schematic view showing signal waveforms of each data line, each scan line, a control signal, and a clock signal according to the first embodiment of the present invention. In the first period PT₁, the source drivers 32 of the source driving circuit 30 may generate first driving signals DS₁₁, DS₁₂ . . . , DS₁ₘ according to the odd line data data_o, and output the signals through the transmission lines 60. Meanwhile, the first switches SW₁ receive the first control signal EN_o and then are turned on. The second switches SW₂ receive the second control signal EN_e and then are turned off. Therefore, the first driving signals DS₁₁, DS₁₂ . . . , DS₁ₘ may be transmitted to an odd number of data lines D(1)_o, D(2)_o . . . , D(m)_o through the first switches SW₁ so as to drive pixels in odd columns of the display panel 50.

In the second period PT₂, the source drivers 32 may generate second driving signals DS₂₁, DS₂₂ . . . , DS₂ₘ according to the even line data data_e and output the signals through the transmission lines 60. Meanwhile, the first switches SW₁ receive the first control signal EN_o and then are turned off. The second switches SW₂ receive the second control signal EN_e and then are turned on. Therefore, the second driving signals DS₂₁, DS₂₂ . . . , DS₂ₘ may be transmitted to an even number of data lines D(1)_e, D(2)_e . . . , D(m)_e through the second switches SW₂, so as to drive pixels in even columns of the display panel 50.

In this embodiment, the voltage levels of the first driving signals DS₁₁, DS₁₃ . . . are opposite to those of the first driving signals DS₁₂, DS₁₄ . . . . The voltage levels of the second driving signals DS₂₁, DS₂₃ . . . are opposite to those of the second driving signals DS₂₂, DS₂₄ . . . . At the beginning of the first period PT₁, the voltage levels of the first driving signals DS₁₁, DS₁₂ . . . , DS₁ₘ are inverted. In addition, at the beginning of the second period PT₂, the voltage levels of the second driving signals DS₂₁, DS₂₂ . . . , DS₂ₙ are inverted. Thus, the polarity is inverted.

In view of the above, in this embodiment, each transmission line 60 may be corresponding to two data lines through the turn on/ff of the first switches SW₁ and the second switches SW₂. That is, in the first period PT₁, the first switches SW₁ are turned on to drive an odd number of data lines D(1)_o to D(m)_o. Moreover, in the second period PT₂, the second switches SW₂ are turned on to drive an even number of data lines D(1)_e to D(m)_e. Therefore, the number of the transmission lines 60 of the source drivers 32 in this embodiment is only a half of those of the conventional source drivers, and thus, the hardware cost is greatly decreased. From another point of view, each output end of the source drivers 32 in this embodiment is corresponding to two data lines, so the number of the source drivers 32 used in this embodiment is only a half of those in the prior art. Therefore, the hardware cost is greatly decreased. Furthermore, in this embodiment, each pixel merely requires for one TFT, and thus the aperture ratio may not be reduced.

It should be noted that, although a possible form of the source driving circuit is described in the above embodiment, persons of ordinary skill in the art may know that, different manufacturers have different designs on the source driving circuit. Therefore, the application of the present invention is not limited to the possible form. In order words, other forms may conform to the spirit of the present invention as long as the source driving circuit uses the switches to enable the transmission lines to transmit the first driving signal in the first period to drive pixels in odd columns, and transmit the second driving signal in the second period to drive pixels in even columns. Hereinafter, another embodiment is illustrated, and persons of ordinary skill in the art may further understand the spirit of the present invention and implement the present invention.

### The Second Embodiment

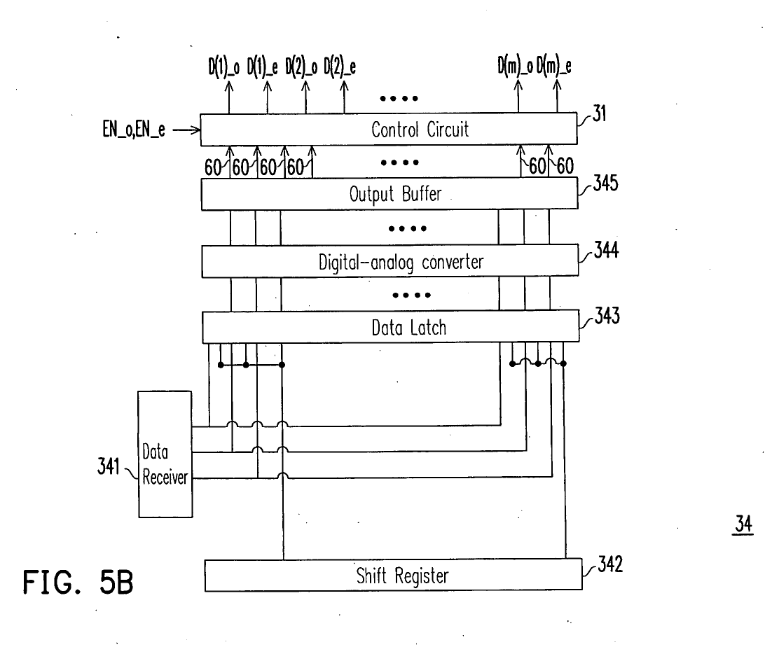

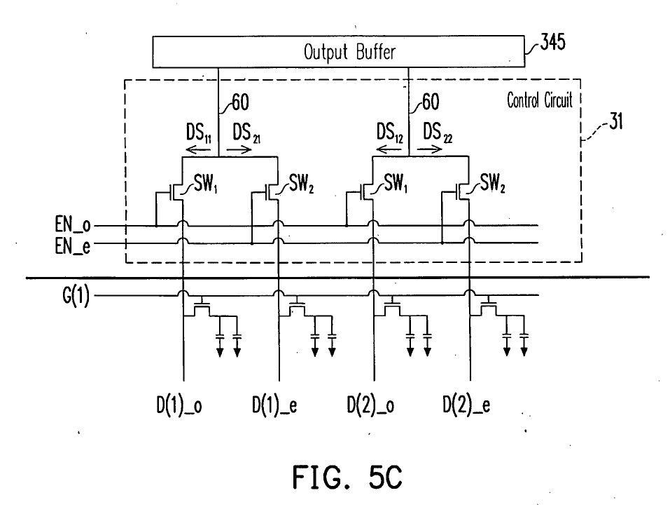

Persons skilled in the art may change the circuit architecture of the source driving circuit as required. For example, FIG. 5A is an architectural view of an LCD according to a second embodiment of the present invention, and FIG. 5B is an architectural view of a source driver according to the second embodiment of the present invention. Referring to FIGS. 5A and 5B, the LCD 11 in this embodiment is similar to the LCD 10 in FIG. 4A, and the difference is described as follows. In this embodiment, the control circuit 31 in the above embodiment is integrated into the source driver 34 of the source driving circuit 33. In more details, the source driver 34 in this embodiment includes a data receiver 341, a shift register 342, a data latch 343, a digital-analog converter (DAC) 344, an output buffer 345, and a control circuit 31. Persons skilled in the art would know the implementations of the data receiver 341, the shift register 342, the data latch 343, the digital-analog converter 344, and the output buffer 345, and the details will not be described herein again.

FIG. 5C is a circuit diagram of a control circuit according to the second embodiment of the present invention. Referring to FIGS. 5A to 5C, provided that the output buffer 345 has m output ends respectively coupled to one transmission line 60, where m is a positive integer larger than 1. The control circuit 31 may be coupled to the output end of the output buffer 345. The control circuit 31 transmits first driving signals DS₁₁, DS₁₂ . . . , DS₁ₘ transmitted by the transmission lines 60 to an odd number of data lines D(1)_o, D(2)_o . . . , D(m)_o through the first switches SW₁ and the second switches SW₂, and transmits second driving signals DS₂₁, DS₂₂ . . . , DS₂ₘ transmitted by the transmission lines 60 to an even number of data lines D(1)_e, D(2)_e . . . , D(m)_e. That is, the N transmission lines 60 in the source driver 34 are corresponding to 2m data lines through the control circuit 31. Therefore, this embodiment may greatly reduce the number of the transmission lines 60 of the source driver 34, so as to decrease the hardware cost.

Then, referring to FIG. 5A, persons skilled in the art may dispose the control signal generator 70 in the above embodiment out of the timing controller 24. In this manner, the first control signal EN_o and the second control signal EN_e may also be generated.

In view of the above, in the present invention, each transmission line of the source driver is provided with the first switches and the second switches, such that each transmission line is corresponding to a plurality of data lines, thereby reducing the hardware cost. Moreover, the embodiment of the present invention at least has the following advantages.

1. Each output end of the source driver is corresponding to two data lines through the control circuit. Therefore, the number of the source drivers in the embodiment of the present invention is only a half of those in the prior art, and thus the hardware cost is decreased.

2. Each pixel in the embodiment of the present invention merely requires for one TFT, and thus the aperture ratio may not be affected.

3. The control circuit may be integrated in the source driver, thus reducing the number of the transmission lines of the source driver.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims and their equivalents.

What is claimed is:

1. A source driving circuit adapted to a display panel, comprising:
a plurality of source drivers, respectively outputting a first driving signal through a plurality of transmission lines in a first period, and outputting a second driving signal through the transmission lines in a second period; and
a plurality of control circuits, respectively coupled to the source drivers, and comprising:
a plurality of first switches, respectively coupled to one of the transmission lines, wherein in the first period the first switches are turned on, such that the first driving signal is transmitted to pixels in odd columns of the display panel; and
a plurality of second switches, respectively coupled to one of the transmission lines, wherein in the second period the second switches are turned on, such that the second driving signal is transmitted to pixels in even columns of the display panel.

2. The source driving circuit according to claim 1, wherein gate ends of the first switches are coupled to a timing controller, so as to receive a first control signal provided by the timing controller, gate ends of the second switches are coupled to the timing controller, so as to receive a second control signal provided by the timing controller, and a voltage level of the first control signal is opposite to that of the second control signal.

3. The source driving circuit according to claim 2, wherein the timing controller comprises a control signal generator, and the control signal generator comprises:
an inverter, receiving a first level signal, and generating a second level signal; and
a level shifter, having a first input end, a second input end, a first output end, and a second output end respectively coupled to an input end of the inverter, an output end of the inverter, the gate ends of the first switches, and the gate ends of the second switches, so as to adjust the voltage level of the first level signal and the voltage level of the second level signal, thereby generating the first control signal and the second control signal.

4. The source driving circuit according to claim 1, wherein the first switches and the second switches are N-channel transistors.

5. The source driving circuit according to claim 1, wherein in the first period, the second switches are situated in a turn-off state, and in the second period, the first switches are situated in a turn-off state.

6. A source driving circuit adapted to a display panel, comprising:
a plurality of source drivers, respectively comprising a plurality of transmission lines, and comprising:
a plurality of first switches, respectively coupled to one of the transmission lines; and
a plurality of second switches, respectively coupled to one of the transmission lines;
wherein in a first period the first switches are turned on, and the source drivers provide a first driving signal to drive pixels in odd columns of the display panel through the transmission lines and the first switches, and in a second period the second switches are turned on, and the source drivers provide a second driving signal to drive pixels in even columns of the display panel through the transmission lines and the second switches.

7. The source driving circuit according to claim 6, wherein gate ends of the first switches are coupled to a timing controller, so as to receive a first control signal provided by the timing controller, gate ends of the second switches are coupled to the timing controller, so as to receive a second control signal provided by the timing controller, and a voltage level of the first control signal is opposite to that of the second control signal.

8. The source driving circuit according to claim 7, wherein the timing controller comprises a control signal generator, and the control signal generator comprises:
an inverter, receiving a first level signal, and generating a second level signal; and
a level shifter, having a first input end, a second input end, a first output end, and a second output end respectively coupled to an input end of the inverter, an output end of the inverter, the gate ends of the first switches, and the gate ends of the second switches, so as to adjust the voltage level of the first level signal and the voltage level of the second level signal, thereby generating the first control signal and the second control signal.

9. The source driving circuit according to claim 6, wherein the first switches and the second switches are N-channel transistors.

10. The source driving circuit according to claim 6, wherein in the first period, the second switches are situated in a turn-off state, and in the second period, the first switches are situated in a turn-off state.
